(19) United States
(12) Patent Application Publication
(10) Pub. No.: US 2021/0192383 A1
(43) Pub. Date: Jun. 24, 2021

(54) SYSTEM AND METHOD FOR AUTOMATIC LEARNING OF REMOTE SENSORS TO AT LEAST ONE CENTRAL COMPUTING DEVICE

(71) Applicant: Lear Corporation, Southfield, MI (US)

(72) Inventors: ROBERT MARIANI, Troy, MI (US); KEITH A. CHRISTENSON, Canton, MI (US); JASON SUMMERFORD, Novi, MI (US); ANDREW J. OZIMEK, Lake Orion, MI (US); CRAIG ELDER, Plymouth, MI (US)

(21) Appl. No.: 16/721,562

(22) Filed: Dec. 19, 2019

(51) Int. Cl. G06N 20/00; H04W 4/38; H04W 84/18; H04W 64/00; H04L 29/08

(52) U.S. Cl. CPC G06N 20/00; H04W 4/38; H04L 67/12; H04W 64/00; H04W 84/18

(57) ABSTRACT

In at least one embodiment, a system for performing automatic learning of a plurality of remote sensors positioned on a first body is provided. The system includes at least one transceiver and at least one central computing device. The central computing device is operably coupled to the at least one transceiver and is configured to wirelessly transmit a broadcast message in response to a user request to each of the remote sensors and to randomly receive a transmission message from one or more of the remote sensors in response to the broadcast message. The central computing device is further configured to determine whether the transmission message from each of the remote sensors have been received and to learn the remote sensors thereto to receive information corresponding to at least one of a command, a status of the first body, or a location of the first body from the remote sensors.

### TECHNICAL FIELD

Aspects disclosed herein generally relate to a system and method for automatic learning of remote sensors to at least one central computing device. These aspects and others will be discussed in more detail below.

### BACKGROUND

U.S. Pat. No. 7,915,997 to King et al. discloses a system and a method for remote activation of a device. The method includes transmitting a command message according to a first modulation, and transmitting a signal representing the command message for the device according to a second modulation. The signal representing the command message transmitted according to the second modulation may be transmitted within the command message transmitted according to the first modulation.

### SUMMARY

In at least one embodiment, a system for performing automatic learning of a plurality of remote sensors positioned on a first body is provided. The system includes at least one transceiver and at least one central computing device. The at least one central computing device being is operably coupled to the at least one transceiver and is configured to wirelessly transmit a broadcast message in response to a user request to each of the plurality of remote sensors and to randomly receive a transmission message from one or more of the plurality of remote sensors in response to the broadcast message. The at least one central computing device is further configured to determine whether the transmission message from each of the plurality of remote sensors have been received and to learn the plurality of remote sensors to the at least one central computing device to enable the at least one central computing device to receive information corresponding to at least one of a command, a status of the first body, or a location of the first body from the plurality of remote sensors after determining that the transmission message from all of the plurality of remote sensors have been successfully received.

In at least another embodiment, a computer-program product embodied in a non-transitory computer readable medium that is programmed for performing automatic learning of a plurality of remote sensors positioned on a first body is provided. The computer-program product includes wirelessly transmitting a broadcast message in response to a user request to each of the plurality of remote sensors and randomly receive a transmission message from one or more of the plurality of remote sensors in response to the broadcast message. The computer-program product includes determining whether the transmission message from each of the plurality of remote sensors have been received and learning the plurality of remote sensors to at least one central computing device to enable the at least one central computing device to receive information corresponding to at least one of a command, a status of the first body, or a location of the first body from the plurality of remote sensors after determining that the transmission message from all of the plurality of messages have been successfully received.

In at least another embodiment, a method for performing automatic learning of a plurality of remote sensors positioned on a first body is provided. The method includes wirelessly transmitting a broadcast message in response to a user request to each of the plurality of remote sensors and randomly receiving a transmission message from one or more of the plurality of remote sensors in response to the broadcast message. The method includes determining whether the transmission message from each of the plurality of remote sensors have been received and learning the plurality of remote sensors to at least one central computing device to enable the at least one central computing device to receive information corresponding to at least one of a command, a status of the first body, or a location of the first body from the plurality of remote sensors after determining that the transmission message from all of the plurality of messages have been successfully received.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a system for automatic learning of a plurality of remote sensors to a central computing device in accordance to one embodiment;

FIG. 2 provides a detailed view of a signal identification exchange between a plurality of transceivers of the central computing device and the plurality of remote sensors after a learning procedure has been performed in accordance to another embodiment;

FIG. 3 depicts a broadcast message as transmitted from the central computing device to the remote sensors in accordance to one embodiment;

FIG. 4 depicts a user interface to enter an identification for the plurality of remote sensors that are remote to the central computing device in accordance to one embodiment;

FIG. 5 depicts one method for automatically learning the remote sensors to the central computing device in accordance to one embodiment;

FIG. 6 depicts a user interface for automatic learning of the plurality of remote sensors that are remote to the central computing device in accordance to one embodiment; and

FIG. 7 depicts another method for automotic learning of the plurality of remote sensors to the central computing device in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilize one or more microprocessors to execute a computer-program that is embodied in a non-transitory computer readable medium that is programmed to perform the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for transmitting and receiving data, respectively, to and from other hardware-based devices as discussed herein.

Aspects disclosed herein generally provide a smart learning method to enable at least one central computing device (or central controller) positioned within, or on a body (e.g., a vehicle, mobile device, etc.) to wirelessly electrically pair with one or more remote sensors that is positioned external to the body. For example, the central computing device may include a first transceiver that broadcasts a message to all corresponding transceivers on respective remote sensors. In this case, the message may correspond to a command to the transceivers to report their unique sensor identifiers. To avoid a message protocol collision from occurring from the various transceivers that report their corresponding unique sensor identifiers to the central computing device, each transceiver reports out their corresponding unique sensor identifier in a random time slot that is a function of their unique identifier. The automatic learning method may be accomplished when the remote sensors are placed in a learning mode. The remote sensors may be placed in a learn mode when manufactured and may remain in the learn mode until they are programmed to the central computing device.

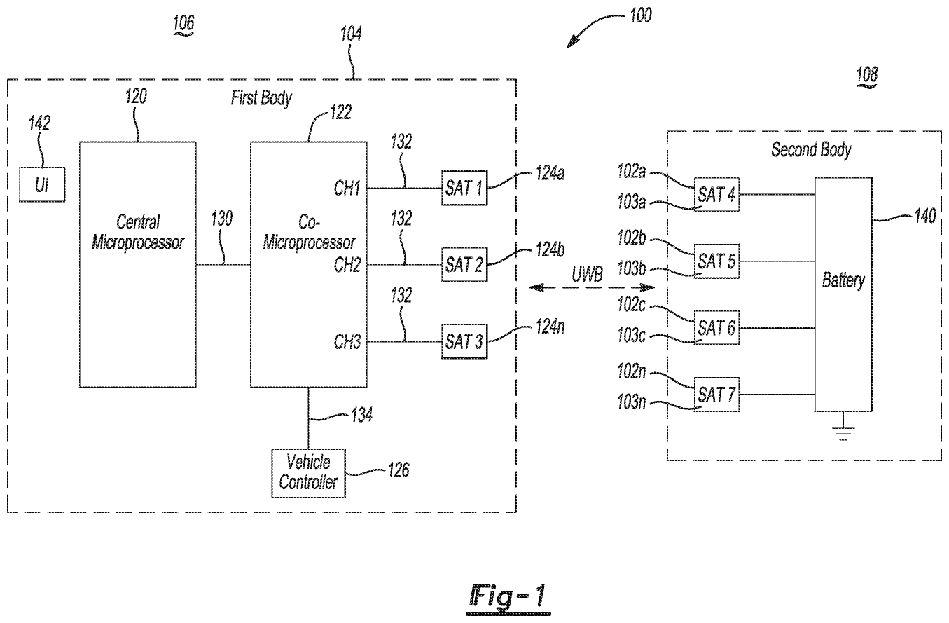

FIG. 1 depicts a system 100 for automatic learning of a plurality of remote sensors 102a-102n (“102”) to at least one central computing device 104 (hereafter “central computing device 104”) in accordance to one embodiment. The central computing device 104 may be positioned on a first body 106. The plurality of remote sensors 102 may be positioned on a second body 108. It is recognized that the plurality of remote sensors 102 may include corresponding transceivers 103 to enable bi-directional wireless communication with the central computing device 104. In general, the system 100 enables the central computing device 104 on the first body 106 to electrical pair, or mate to the plurality of remote sensors 102 that are positioned on the second body 108. After the central computing device 104 is electrically paired to the plurality of remote sensors 102, the central computing device 104 is configured to engage in wireless bi-directional communication with the plurality of remote sensors. 102 to perform various functional aspects as desired by a user.

It is recognized that the system 100 may be employed for any number of applications. For example, the system 100 may be employed with, but not limited to, a vehicle tire pressure monitoring system, a system for monitoring a location of vehicle seats once the seats are removed from the vehicle, an asset tracking system in which a mobile device can track the location of luggage, a vehicle remote keyless system (or passive entry passive start system (PEPS), etc. In light of the foregoing, the first body 106 may correspond to a vehicle, a mobile device, tablet, etc. The second body 108 may correspond to a keyfob, vehicle tires/wheels, luggage, vehicle seats, etc.

Consider that the system may be utilized in connection with a vehicle tire pressure monitoring system. In this case, the central computing device 104 may be positioned within an interior of the vehicle (or in a vehicle engine compartment) and the plurality of remote sensors 102a-102n may correspond to tire pressure monitoring sensors in which a corresponding remote sensor 102 is positioned on a respective wheel/tire of the vehicle. With this system, the tire pressure sensors may communicate tire pressure to a corresponding tire of the vehicle. Prior to the tire pressure sensors communicating a tire pressure to the central computing device 104, the tire pressure sensors need to be electrically paired (or learned) to the central computing device 104 since the sensors are shipped separately from the central computing device 104 to a vehicle assembly plant. The interior of the vehicle or the engine compartment that receives the central computing device 104 may correspond to the first body 106 and the tire/wheel that receives the tire pressure sensor serves as the second body 108.

In the example of the vehicle remote keyless system, the central computing device 104 may be positioned within an interior of the vehicle (or in the vehicle engine compartment) and a corresponding remote sensor 102 may be positioned within a corresponding key fob. With this system, the key fob may communicate with the central computing device to unlock/lock doors of the vehicle. Additionally or alternatively, the key fob and the central computing device 104 may communicate with one another to start the vehicle Prior to the keyfob transmitting unlock/lock commands to the central computing device 104 (or the keyfob and the central computing device 104 enabling the vehicle to start), the keyfob needs to be electrically paired (or learned) to the central computing device 104 since the keyfob may be shipped separately from the central computing device 104 to a vehicle assembly plant. The interior of the vehicle or the engine compartment that receives the central computing device 104 may correspond to the first body 106 and the keyfob that receives the remote sensor serves as the second body 108.

In the example of the system for monitoring vehicle seats, the central computing device 104 may be positioned on a mobile device and a corresponding remote sensor 102 may be positioned on a particular vehicle seat. With this system, the remote sensor 102 may communicate with the central computing device 104 to provide a location of the vehicle seat when such a seat is removed from the vehicle. This implementation may be beneficial for automotive manufactures who manufacture vehicles that enable vehicle seats to be removed from a vehicle (e.g., minivan, etc.). Assume for example that a vehicle is undergoing repair and that its corresponding vehicle seats are removed from the vehicle and spread about a repair shop with other vehicle seats. The system for monitoring vehicle seats may ascertain the location and actual position (e.g., front driver seat, front passenger seat, rear driver's side seat, passenger side seat, etc.) of the seat based on such information as provided by the remote sensors 102. Prior to the central computing device 104 and the remote sensors 102 communicating with one another, the remote sensors 102 on the seats need to be electrically paired (or learned) to the central computing device 104 since the remote sensors may be shipped separately from the central computing device 104. The mobile device that receives the central computing device 104 may correspond to the first body 106 and the vehicle seats that receives the remote sensors 102 may be the second body 108.

In the example of the tracking asset system, the central computing device 104 may be positioned within the mobile device and the plurality of remote sensors 102a-102n may each be positioned on a corresponding piece of luggage. With this system, the remote sensor 102 may communicate with the central computing device 104 to provide a location of the luggage and to further provide an identification of the owner of the luggage. This system allows a user to track his/her luggage in airports or other establishments. Further, the system provides an identification of the owner of the luggage to prevent the luggage from being inadvertently carried away by another person. Prior to the central computing device 104 and the remote sensors 102 communicating with one another, the remote sensors on the luggage need to be electrically paired (or learned) to the central computing device 104 since the remote sensors may be shipped separately from the central computing device 104. The mobile device that receives the central computing device 104 may correspond to the first body 106 and the luggage that receives the remote sensors 102 may be the second body 108.

It is recognized that the systems identified above may utilize any number of wireless communication protocols to communicate with one another such as for example, BLUETOOTH, Low Energy BLUETOOTH, etc. or frequency-based transmissions such as such as ultra-wide band (UWB), radio frequency (RF), etc. The particular type of communication protocol used to enable communication between the central computing device 104 and the remote sensors 102 may vary based on the particular application that such devices are utilized for.

The system 100 as illustrated in FIG. 1 utilizes UWB based communication to enable bi-directional communication between the central computing device 104 and the plurality of remote sensors 102. The central computing device 104 as illustrated in FIG. 1 will be described for use with one or more of the vehicle applications as noted above. The central computing device 104 includes a central microprocessor 120, co-microprocessor 122, a plurality of central transceivers 124a-124n (“124), and an application controller 126. The co-microprocessor 122 may receive data from the central microprocessor 120 and provide the same in a format that is suitable for transmission from the central transceivers 124 to the remote sensors 102 positioned on the second body 108. The co-microprocessor 122 may transmit data to the application controller 126. It is recognized the each of the central microprocessor 120, the co-microprocessor 122, the application controller 126 may engage in bi-directional communication with one another.

The central microprocessor 120 and the co-microprocessor 122 may communicate with one another via a first communication data bus 130. In one example, the first communication data bus 130 may correspond to a Universal Serial Bus (USB). The co-microprocessor 122 and the plurality of central transceivers 124 may communicate with one another via a second communication data bus 132. In one example, the second communication data bus 132 may correspond to a Local Interconnect Network (LIN) bus. The co-microprocessor 122 may communicate with the application controller 126 via a third communication data bus 134. The third communication data bus 134 may be implemented as a Controller Area Network (CAN) bus. The third communication data bus 134 may transmit/receive data at a faster rate than the first communication data bus 130 and the second communication data bus 132.

One or more of the remote sensors 102 as positioned on the second body 108 may be coupled to a power supply 140. The power supply 140 may provide power to the remote sensors 102. As noted above, it is generally necessary to electrically pair the central computing device 104 with the plurality of remote sensors 102 given that the central computing device 104 and the plurality of remote sensors 102 may be provided by two different sources (i.e., suppliers or providers). To this end, the plurality of remote sensors 102 may be placed in a listen mode (or learn mode) after such sensors are manufactured and shipped to a distribution facility or assembly plant. While in the learn mode, the plurality of remote sensors 102 may configured to wait for a message from the central computing device 104 to initiate the pairing process. Likewise, the central computing device 104 may be in a learn mode. In this mode, the central computing device 104 is configured to receive messages from the remote sensors 102 to perform the pairing operation. While the central computing device 104 is in the learn mode, the device 104 may be considered to be in an unsecure mode since it can receive encrypted data (or key information) along with sensor identification information in the message from the remote sensors 102 during the pairing operation. Likewise, the transceiver 103 and the central transceiver 124a-124n may be in an unsecure mode.

To initiate the process of pairing the central computing device 104 to the remote sensors 102, a user may, via a user interface 142, control the central computing device 104 to wirelessly transmit a broadcast message to the one or more remote sensors 102. In response to the broadcast message, each remote sensor 102 transmits a transmission message back to central computing device 104. The transmission message generally includes sensor identification information (e.g., unique identifier) for the central computing device 104 to recognize that the transmission message is from an authorized transmitter. The transmission message may also include status information such as sensor health, sensor battery status, etc. (e.g., for the remote sensor 102). The central computing device 104 receives the transmission message from the various remote sensors 102 and authenticates the predetermined information to determine if the transmission message from the remote sensor 102 is from an authorized transmitter. The transmission messages may be transmitted randomly (e.g., in any time sequence) by the remote sensors 102 to the central computing device 104. It is recognized that any two or more transmission messages as transmitted by the remote sensor 102 may be transmitted at the same time. Likewise, any two or more transmission messages as received at the central computing device 104 may be received at the same time at the transceivers 124a-124n of the central computing device 10.

The central computing device 104 is generally programmed, based on the application, to electrically pair with a predetermined number of remote sensors 102. Thus, considering for example that the central computing device 104 and the remote sensors 102 are used in connection with a tire pressure monitoring system, if the central computing device 104 does not a receive a transmission message from a total of 5 remote sensors (e.g., a remote sensor 102 for each sensor on a tire including a spare tire), the central computing device 104 refrains from pairing any of the remote sensors 102 thereto until the number of received transmission messages is equal to the number of remote sensors that are to be used for the particular system or application. After the central computing device 104 determines that all of the transmission messages from all corresponding remote sensors 102 have been received, the remote sensors 102 are successfully paired (or learned) to the central computing device 104 and the remote sensors 102 may then transmit information corresponding to at least one of a command, a status of the first body, or a location of the first body from the plurality of remote sensors 102. One example of a command transmitted by the remote sensors 102 may correspond to a door lock command from a keyfob. One example of the status of the first body as transmitted by the remote sensors 102 may correspond to a pressure reading of a tire. One example of a location of the first body as transmitted by the remote sensors 102 may include the location of luggage or vehicle seat.

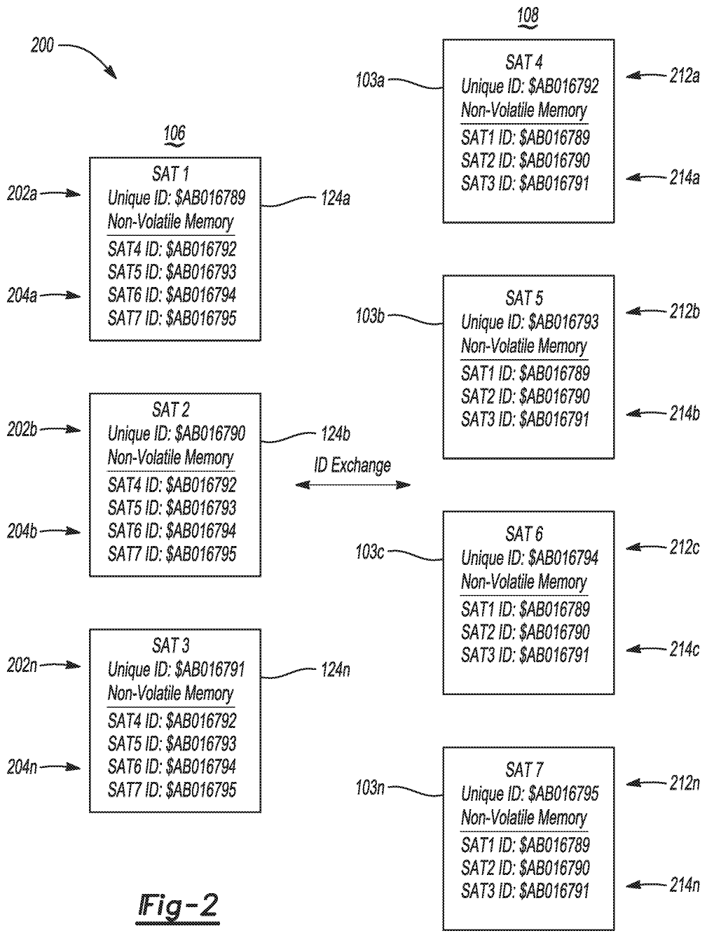

FIG. 2 provides a detailed view of a signal identification exchange 200 between the plurality of central transceivers 124a-124n positioned on the first body 106 and the plurality of transceivers 103a-103n of respective remote sensors 102a-102n after a learning procedure has been performed in accordance to another embodiment. As noted above, the system 100 may utilize UWB based communication to enable bi-directional communication between the central computing device 104 and the plurality of remote sensors 102.

The method for performing the automatic learning of the remote sensors 102 to the central computing device 104 generally involves the remote sensor 102 exchanging identification information with the central computing device 104. For example, the co-microprocessor 122 may include a UWB controller (not shown). Additionally or alternatively, the UWB controller may be positioned in any one or more of the central transceivers 124a-124n. Typically, the UWB controller may encode, for example, a unique 32-bit identifier into each controller that is manufactured. If the UWB controller does not have an identifier, then the unique bit identifier can be created at the time the central computing device 104 is manufactured and this can be stored in non-volatile memory of the central computing device 104. A UWB message may include a source field and a destination field. The source field of the UWB message may include unique identifiers for the device transmitting the message and the destination field may contain a unique identifier for the device that receives the message.

As shown in FIG. 2, each central transceiver 124a-124n includes a source field 202a-202n and a destination field 204a-204n. In a similar manner, each of the transceivers 103a-103n includes a source field 212a-212n and a destination field 214a-214n. The central transceiver 124a includes a unique identifier for itself (e.g., $ABO016789) in the source filed 202a and a unique identifier for the various transceivers 103a-103n of the remote sensors 102a-102n that the central transceiver 124a communicates with. In this instance, the destination field 204a of the central transceiver 124a includes the unique identifiers for the transceivers 103a-103n of the remote sensors 102a-102n which may be, for example, $ABO016792, $ABO016793, $ABO016794, $ABO016795, respectively. The remaining central transceivers 124b-124n will be arranged in a similar manner. However, each central transceiver 124b-124n will include a unique identifier in the source field 202b-202n that is different from one another. Likewise, each source field 212a-212n for the transceivers 103a-103n will be different from one another. The destination fields 214a-214n for the transceivers 103a-103n include the corresponding unique identifiers for the central transceivers 124a-124n.

The following description provides an overview of various UWB message traffic that may be supported by the central transceivers 124a-124n on the first body 106 and the transceivers 103a-103n on the second body 108. The central computing device 104 may transmit a broadcast message to the remote sensors 102a-102n while these devices are in the learn mode. In response to receiving the broadcast message, each transceiver 103a-103n of the remote sensors 102a-102n transmits its corresponding unique identifier as positioned within its corresponding source field 212a-212n. One or more of the central transceivers 124a-124n may be transmit a first targeted message to any one or more of the transceivers 103a-103n of the remote sensors 102a-102n. The first targeted message may include secret key information and all the unique identifiers for the central transceivers 124a-124n. The secret key may be used by the central transceivers 124a-124n and the transceivers 103a-103n to communicate encrypted data to each other. The secret key may be part of an encryption algorithm such as for example, AES128. Each of the noted systems may have a unique secret key. The secret key may include any number of bits. For AES128, the secret key may be 128 bits long.

One or more of the central transceivers 124a-124n may transmit a second targeted message to any one or more of the transceivers 103a-103n of the remote sensors 102a-102n. The second targeted message may include a request for any one or more of the remote sensors 102a-102n to respond with its corresponding operating mode (e.g., learn mode (where remote sensor 102a-102n where the sensors 102a-102n are ready to be electrically paired to the central computing device 104) or normal mode (where the remote sensors 102a-102n are already electrically paired to the central computing device 104).

One or more of the central transceivers 124a-124n may transmit a third targeted message to any one or more of the transceivers 103a-103n of the remote sensors 102a-102n. The third targeted message may include a request to range with any one or more of the remote sensors 102a-102n. In this example, the third targeted message may correspond to a request for the remote sensors 102 to transmit data so that the central computing device 104 may perform time of flight measurements. For example, the central computing device 104 may initiate a timer from the moment the first targeted message is transmitted therefrom to the moment in which the range information from the remote sensors 102 is received to ascertain the time of flight. Range information or range data may be exchanged between the central transceivers 124a-124n and the remote sensors 102a-102n. The range data may include multiple UWB frames. The exchanged frames include time stamps with nanosecond accuracy. The central transceivers 124a-124n may collect the time stamps and may determine a time of flight which is then converted to a range in meters.

One or more of the central transceivers 124a-124n may transmit a fourth targeted message to any one or more of the transceivers 103a-103n of the remote sensors 102a-102n. The fourth targeted message may include a request for any one or more of the remote sensors 102a-102n to transition from the learn mode to the normal mode. Pairing may be one part of the learn process. In the general, the central computing device 104 may also want to confirm that each remote sensor 102a-102n can be successfully targeted and provide range data that is plausible. At that point, the remote sensors 102a-102n transition to the normal mode. This aspect provides more flexibility for the system.

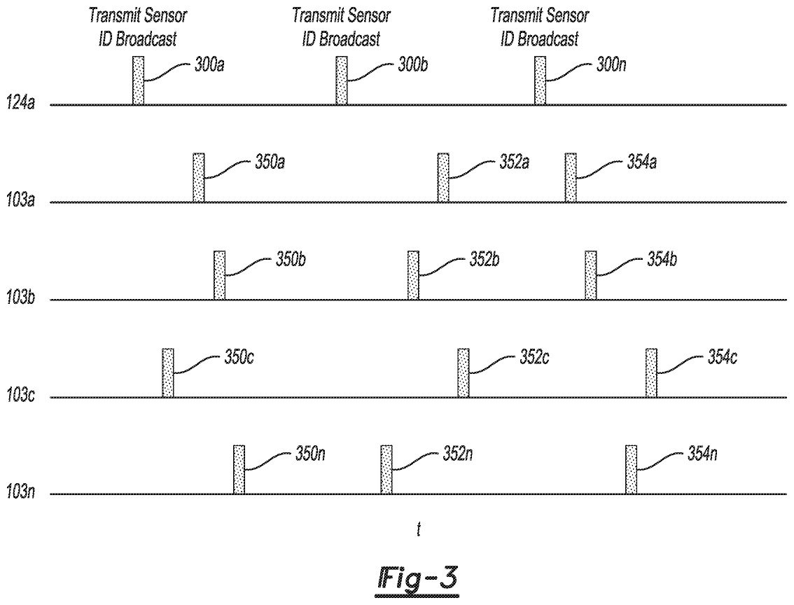

FIG. 3 depicts various broadcast messages 300a-300n as transmitted from the central computing device 104 and signal responses 350a-350n, 352a-352n, 354a-354n to the broadcast messages 300a-300n as transmitted from the plurality of remote sensors 102a-102n in accordance to one embodiment. When it is desirable to electrically pair the remote sensors 102a-102n, the central computing device 104 may transmit the plurality of broadcast messages 300a-300n for a predetermined amount of time. In this case, the central computing device 104 and the plurality of remote sensors 102 may be in the learn mode.

As shown, the corresponding remote sensors 102a-102n may transmit the signal responses 350a-350n in response to the broadcast message 300a as transmitted by the central transceiver 124a. In general, the central computing device 104 is configured to receive the signal responses 350a-350n randomly. Prior to the central computing device 104 exiting the learn mode or acknowledging that the remote sensors 102a-102n have been learned to the central computing device 104, the central computing device 104 may transmit the broadcast message a predetermined number of times to ensure that the central computing device 104 receives a signal response from the correct number of remote sensors 102a-102n. In general, each central computing device 104, depending on the application that it is used for, may be programmed to interface with a predetermined number of remote sensors 102a-102n. For example, consider the example of the vehicle seat tracking application, the central computing device 104 may be programmed to interface with a total of four seats with each seat having a corresponding remote sensor 102. For this application, the central computing device 104 may be programmed to interface with a total of four remote sensors 102a-102n. If the central computing device 104 does not receive a signal response in the learn mode from all four of the remote sensors 102 in response to the broadcast message 300, then the central computing device 104 will not electrically pair with the remote sensors 102. Likewise, if more than the predetermined number of remote sensors 102 have transmitted a signal response, then the central computing device 104 will fail the electronic pairing operation.

To ensure that the proper number of remote sensors 102 are being utilized for a particular application, the central computing device 104 may transmit a predetermined number of broadcast messages 300a-300n to ensure that the same number of signal responses from the remote sensors 102 have been received in response to each broadcast message being sent. FIG. 3 illustrates that the signal responses 352a-352n have been randomly received in response to the broadcast message 300b being sent. Likewise, it is shown that the signal responses 354a-354n have been received in response to the broadcast message 300n being sent. For this particular application, it is assumed that the central computing device 104 expects (or is programmed) to receive a total of three signal responses from a total of three remote sensors. Given that a total of three signal responses have been received in response to each broadcast message 300a-300n that was transmitted, the central computing device 104 determines that the learn operation was successful and initiates interfacing with the various remote sensors 102 of the system in a normal operating mode.

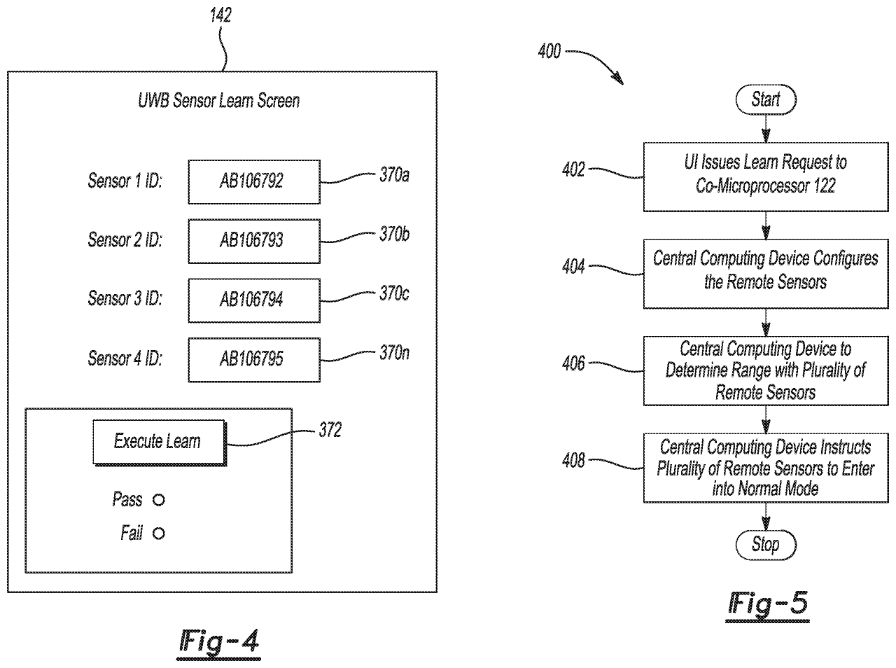

FIG. 4 depicts the user interface 142 to manually enter a unique identifier for each of the plurality of remote sensors 102 that are remote to the central computing device 104 in accordance to one embodiment. The user interface 142 includes a plurality of identification fields 370a-370n with each field being configured to manually receive a unique identifier input by a user for a corresponding remote sensor 102. Once the unique identifiers for each remote sensor 102 is entered, the user may select an execute field 372 to initiate the learn procedure. The learn procedure exchanges all unique identifiers (e.g., the unique identifiers for the central transceivers 124a-124n are transmitted to the remote sensors 102 and the unique identifiers for the remote sensors 102a-102n are transmitted back to the central transceivers 124a-124n of the central computing device 104. A communication test may be performed to verify that the central transceivers 124a-124n and the remote sensors 102a-102n properly communicate with one another.

FIG. 5 depicts a method 400 for automatically learning the remote sensors 102 to the central computing device 104 based on the apparatus of FIG. 4.

In operation 402, the user interface 142 transmits a learn request to the co-microprocessor 122 via the central microprocessor 120. For example, the learn request readies the co-microprocessor 122 to provide secret key information and the unique identifiers for the remote sensors 102 as input by the user into the user interface 142. The co-microprocessor 122 instructs the central transceivers 124a-124n to initiate the learning sequence.

In operation 404, the co-microprocessor 122 controls the central transceiver 124a to transmit the second targeted message to the remote sensors 102 to determine if the remote sensors 102 are in the learn mode. In the event the signals from the remote sensors 102 indicate that all of the remote sensors 102 are in the learn mode, then the method 400 moves to operation 406. In general, the remote sensors 102 are required to be in a learn mode before the central computing device 104 configures the remote sensor 102 with the secret key. If any of the remote sensors 102 provide a response indicating that they are not in the learn mode, then the learn process fails. For example, if any remote sensor 102 is not in the learn mode, then the learn process fails and the user interface 142 provides an error message.

In operation 406, the co-microprocessor 122 controls the central transceiver 124a to transmit the third targeted message to the remote sensors 102. As noted above, the third targeted message corresponds to a command for each remote sensor 102a-102n to send a signal with range data. The central computing device 104 verifies the range data and measures the time of flight for each signal received back from a corresponding remote sensor 102 to ensure that the range data is valid and to further ensure that the time of flight for the signals from the remote sensors 102 are within a predetermined time frame. As noted above, the signals are received back from the remote sensors 102 are received in a random fashion. In one example, the central computing device 104 may determine range\distance based on time of flight between, for example, two to three UWB messages being transmitted from central transceivers 124a-124n and the remote sensors 102a-102n.

In operation 408, the co-microprocessor 122 controls the central transceiver 124a to transmit the fourth targeted message to the remote sensors 102. As noted above, the fourth targeted message corresponds to a command to control the remote sensors 102 to exit the learn mode and to enter into the normal mode to perform expected functions for the application that such devices are intended to operate within (e.g., tire pressure monitoring, vehicle seat tracking, RKE/PEPS, or asset tracking). The remote sensors 102 transmit a message back to the central computing device 104 to indicate that the remote sensors 102 are in the normal mode. Upon receiving the messages, the central computing device 104 controls the user interface to provide an indication to the user that the remote sensors 102 have been successfully paired to the central computing device 104.

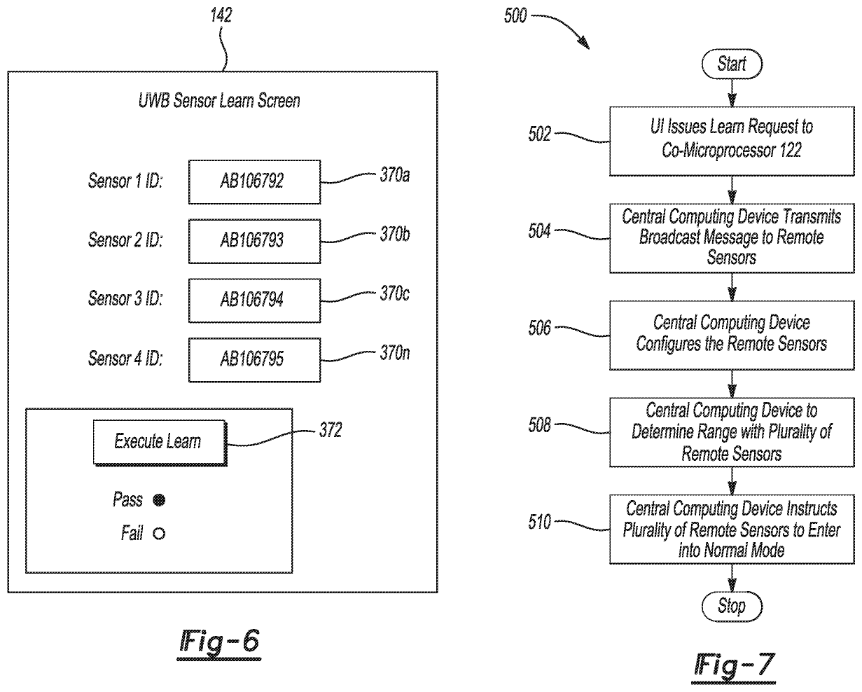

FIG. 6 depicts the user interface 142 that enables each of the plurality of remote sensors 102 that are remote to the central computing device 104 to be automatically learned to the central computing device 104 in accordance to one embodiment. In general, the user interface 142 as illustrated in FIG. 6 is generally similar to the user interface 142 of FIG. 4. However, the user interface 142 of FIG. 6 interfaces with the central computing device 104 to automatically pair (or program) the remote sensors 102 to the central computing device 104. Thus, the user interface 142 is not required to manually input the unique identifiers for the remote sensors 102 into the various plurality of identification fields 370a-370n. Rather, upon the user selecting the execute field 372 of the user interface 142, the central computing device 104 automatically and wirelessly transmits the broadcast message(s) to the remote sensors 102 in order for the remote sensors 102 to provide their respective unique identifiers. Once the pairing process is complete, the identification fields 370a-370n automatically display the unique identifier for the remote sensors 102a-102n, respectively. Once the pairing operation is complete, the remote sensors 102 may then transmit information corresponding to at least one of a command (e.g., door lock command from a key fob), a status of the first body (e.g., pressure reading of tire), or a location of the first body (e.g., location of luggage) from the plurality of remote sensors 102. The pairing procedure as performed by the central computing device 104 and the remote sensors 102 will be discussed in more detail in connection with FIG. 7.

FIG. 7 depicts another method for automatic learning of the plurality of remote sensors 102 to the central computing device 104 in accordance to one embodiment.

In operation 502, the user interface 142 transmits a learn request to the co-microprocessor 122 via the central microprocessor 120. For example, the learn request readies the co-microprocessor 122 to provide secret key information and the unique identifiers for the remote sensors 102 as input by the user into the user interface 142. The co-microprocessor 122 instructs the central transceivers 124a-124n to initiate the learning sequence.

In operation 504, the central computing device 104 instructs the central transceivers 124a-124n to wirelessly transmit, via UWB, the broadcast message to the remote sensors 102a-102n. The broadcast message corresponds to a request for the remote sensors 102a-102n to provide their respective unique identifiers. In response to the broadcast message, the remote sensors 102a-102n transmit their respective unique identifiers to the central computing device 104. The unique identifiers may be transmitted randomly (e.g., in any time sequence) by the remote sensors 102 to the central computing device 104. It is recognized that any two or more unique identifiers as transmitted by the remote sensor 102 may be transmitted at the same time. Alternatively, all of the unique identifiers may be transmitted at different times from one another. Any two or more transmission messages as received at the central computing device 104 may be received at the same time at the transceivers 124a-124n of the central computing device 10. Alternatively, all of the unique identifiers may be received at the central computing device 104 at different times from one another. The central computing device 104 records the total number of unique identifiers that are received from the remote sensors 102. In this case, the central computing device 104 determines if the total number of received unique identifiers is equal to the predetermined number of remote sensors 102 that are positioned on the second body 108. If this condition is true, then the method 500 proceeds to operation 506. If for example, the total number of received unique identifiers is less than or greater than the predetermined number of remote sensors 102, then the learning process fails and the method 500 ends.

In operation 506, the co-microprocessor 122 controls the central transceiver 124a to transmit the second targeted message to the remote sensors 102 to determine if the remote sensors 102 are in the learn mode. In the event the signals from the remote sensors 102 indicate that all of the remote sensors 102 are in the learn mode, then the method 500 moves to operation 508. In operation 506, the co-microprocessor 122 may configure the remote sensors 102 with secret key.

In operation 508, the co-microprocessor 122 controls the central transceiver 124a to transmit the third targeted message to the remote sensors 102. As noted above, the third targeted message corresponds to a command for each remote sensor 102a-102n to send a signal with range data. The central computing device 104 verifies the range data and measures the time of flight for each signal received back from a corresponding remote sensor 102 to ensure that the range data is valid and to further ensure that the time of flight for the signals from the remote sensors 102 are within a predetermined time frame. As noted above, the signals are received back from the remote sensors 102 in a random fashion.

In operation 510, the co-microprocessor 122 controls the central transceiver 124a to transmit the fourth targeted message to the remote sensors 102. As noted above, the fourth targeted message corresponds to a command to control the remote sensors 102 to exit the learn mode and to enter into the normal mode to perform expected functions for the application such that the devices are intended to operate within (e.g., tire pressure monitoring, vehicle seat tracking, RKE/PEPS, or asset tracking). The remote sensors 102 transmit a message back to the central computing device 104 to indicate that the remote sensors 102 are in the normal mode. Upon receiving the messages, the central computing device 104 controls the user interface to provide an indication to the user that the remote sensors 102 have been successfully paired to the central computing device 104. After the central computing device 104 determines that all of the unique identifiers from all corresponding remote sensors 102 have been received, the remote sensors 102 are successfully paired (or learned) to the central computing device 104. The remote sensors 102 may then transmit information corresponding to at least one of a command (e.g., door lock command from key fob), a status of the first body (e.g., pressure reading of tire), or a location of the first body (e.g., location of luggage) from the plurality of remote sensors 102.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for performing automatic learning of a plurality of remote sensors positioned on a first body, the system comprising:
at least one transceiver; and
at least one central computing device being operably coupled to the at least one transceiver and being configured to:
wirelessly transmit a broadcast message in response to a user request to each of the plurality of remote sensors,
randomly receive a transmission message from one or more of the plurality of remote sensors in response to the broadcast message,
determine whether the transmission message from each of the plurality of remote sensors have been received; and
learn the plurality of remote sensors to the at least one central computing device to enable the at least one central computing device to receive information corresponding to at least one of a command, a status of the first body, or a location of the first body from the plurality of remote sensors after determining that the transmission message from all of the plurality of remote sensors have been successfully received.

2. The system of claim 1, wherein the at least one central computing device is further configured to refrain from learning the plurality of remote sensors thereto after determining that the transmission message from one or more of the plurality of remote sensors have not been received.

3. The system of claim 1, wherein the at least one central computing device is further configured to wirelessly transmit the broadcast message a predetermined number of times to the plurality of remote sensors and to determine whether the transmission message from each of the plurality of remote sensors have been received for every occurrence of the broadcast message being transmitted.

4. The system of claim 1, wherein the transmission message from each of the plurality of remote sensors includes a unique identifier that identifies a particular remote sensor from the plurality of remote sensors.

5. The system of claim 1, wherein the at least one central computing device is further configured to transmit a first targeted message to each of the plurality of remote sensors prior to transmitting the broadcast message to determine if each of the plurality of remote sensors is in a learn mode that enables the each of the remote sensors to randomly transmit the transmission message to the at least one central computing device.

6. The system of claim 5, wherein the at least one central computing device is further configured to receive a first message from each of the plurality of remote sensors indicative of whether each of the plurality of remote sensors is in the learn mode and to disable learning the plurality of remote sensors thereto in response to the first message indicating that any one or more of the plurality of remote sensors are not in a learn mode.

7. The system of claim 1, wherein the at least one central computing device is further configured to transmit a first targeted message to each of the plurality of remote sensors indicative of a command for each of the plurality of remote sensors to transmit range data to the at least one central computing device.

8. The system of claim 7, wherein the at least one central computing device is further configured to perform a time of flight measurement that is initiated upon the transmission of the first targeted message to each of the plurality of remote sensors and terminated upon a receipt of the range data of the plurality of remote sensors to determine if the time of flight measurement is within a predetermined time frame prior to learning the remote sensors thereto.

9. A computer-program product embodied in a non-transitory computer readable medium that is programmed for performing automatic learning of a plurality of remote sensors positioned on a first body, the system comprising:
wirelessly transmitting a broadcast message in response to a user request to each of the plurality of remote sensors,
randomly receive a transmission message from one or more of the plurality of remote sensors in response to the broadcast message,
determine whether the transmission message from each of the plurality of remote sensors have been received; and
learn the plurality of remote sensors to at least one central computing device to enable the at least one central computing device to receive information corresponding to at least one of a command, a status of the first body, or a location of the first body from the plurality of remote sensors after determining that the transmission message from all of the plurality of messages have been successfully received.

10. The computer-program product of claim 9 further comprising instructions to refrain from learning the plurality of remote sensors to the at least one central computing device after determining that the transmission message from one or more of the plurality of remote sensors have not been received.

11. The computer-program product of claim 9 further comprising instructions to wirelessly transmit the broadcast message a predetermined number of times to the plurality of remote sensors and to determine whether the transmission message from each of the plurality of remote sensors have been received for every occurrence of the broadcast message being transmitted.

12. The computer-program product of claim 9, wherein the transmission message from each of the plurality of remote sensors includes a unique identifier that identifies a particular remote sensor from the plurality of remote sensors.

13. The computer-program product of claim 9 further comprising instructions to transmit a first targeted message to each of the plurality of remote sensors prior to transmitting the broadcast message to determine if each of the plurality of remote sensors is in a learn mode that enables each of the plurality of remote sensors to randomly transmit the transmission message to the at least one central computing device.

14. The computer-program product of claim 13 further comprising instructions to receive a first message from each of the plurality of remote sensors indicative of whether each of the plurality of remote sensors is in the learn mode and to disable the operation of learning the plurality of remote sensors thereto in response the first message indicating that any one or more of the remote sensors are not in a learn mode.

15. The computer-program product of claim 9 further comprising instructions to transmit a first targeted message to each of the plurality of remote sensors indicative of a command for each of the plurality of remote sensors to transmit range data to the at least one central computing device.

16. The computer-program product of claim 15 further comprising instructions to perform a time of flight measurement that is initiated upon the transmission of one or more of the first targeted message to each of the plurality of remote sensors and terminated upon the receipt of the range data of the plurality of remote sensors to determine if the time of flight measurement is within a predetermined time frame prior to learning the remote sensors thereto.

17. A method for performing automatic learning of a plurality of remote sensors positioned on a first body to at least one central computing device, the method comprising:
wirelessly transmitting a broadcast message in response to a user request to each of the plurality of remote sensors,
randomly receiving a transmission message from one or more of the plurality of remote sensors in response to the broadcast message,
determining whether the transmission message from each of the plurality of remote sensors have been received at the at least one central computing device; and
learning the plurality of remote sensors to at least one central computing device to enable the at least one central computing device to receive information corresponding to at least one of a command, a status of the first body, or a location of the first body from the plurality of remote sensors after determining that the transmission message from all of the plurality of remote sensors have been successfully received.

18. The method of claim 17 further comprising instructions to refrain from learning the plurality of remote sensors to the at least one central computing device after determining that the transmission message from one or more of the plurality of remote sensors have not been received.

19. The method of claim 17 further comprising instructions to wirelessly transmit the broadcast message a predetermined number of times to the plurality of remote sensors and to determine whether the transmission message from each of the plurality of remote sensors have been received for every occurrence of the broadcast message being transmitted.

20. The method of claim 17, wherein the transmission message from each of the plurality of remote sensors includes a unique identifier that identifiers a particular remote sensor from the plurality of remote sensors.
